(19) United States
(12) Patent Application Publication
(10) Pub. No.: US 2007/0237435 A1
(43) Pub. Date: Oct. 11, 2007

(54) Linear Motion Guide Unit And Method For Detecting Strain On The Same

(76) Inventors: Shouji Nagao, Kamakura-shi (JP); Hironori Yamamoto, Kamakura-shi (JP)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/691,781

(22) Filed: Mar. 27, 2007

(30) Foreign Application Priority Data
Mar. 29, 2006 (JP) 2006-090961

(51) Int. Cl. F16C 29/06

(52) U.S. Cl. 384/44

(57) ABSTRACT

A linear motion guide unit, having force-information detecting means and enabling reductions in size and manufacturing cost, is provided with a casing having a mounting portion combined with two wings which have rolling-contact faces facing a track rail and return holes interconnecting with the rolling-contact faces and incorporate rollers rolling through the rolling-contact faces and the return holes. The rollers move the casing along the track rail while rolling between the rolling-contact faces and the track rail. A load acts on the casing and a force acts on the wings in the direction of moving them farther away from each other. Bulge portions are created on the outer side-faces of the wings by the action of the force, in which tensile-strain detection sensors are provided. Compressive-strain detection sensors are provided in depression portions created next to the bulge portion closer to the mounting portion when the bulge portions are created.

### FIELD OF THE INVENTION

This invention relates to a linear motion guide unit capable of detecting strain occurring in accordance with the load on its casing, and a method for detecting the strain.

### DESCRIPTION OF THE RELATED ART

A generally known linear motion guide unit of this type is as disclosed in Japanese Patent No. 2673849, for example.

The conventional linear motion guide unit incorporates a plurality of rolling elements which can roll between the linear motion guide unit and track rails to make their relative movement smooth. The linear motion guide unit is provided with an elastic member which is a separate member from the main body, and an elastic mechanism comprising a thin-walled portion which is formed by machining the main body.

Upon the action of a load on the main body, the load induces displacement of the elastic mechanism, and a detection means such as a sensor detects the amount of displacement of the elastic mechanism to obtain force information about the load direction, the magnitude of the load and the like.

The force information thus obtained can be used for detection of a change in the shape of a tool and of abnormal conditions of the tool, and for the detection of conditions of work such as shape recognition and processing situation. The force information under normal conditions is stored in a computer in advance. By making a comparison between the numerical values stored in the computer and the numerical values detected by the detection means, the conditions of work, the rail, the tool, the apparatus or the like can be detected. Such detection of various conditions enables the prevention of the failure of the apparatus and quick dealing with the cause of the failure.

In the conventional linear motion guide unit, the elastic mechanism undergoing displacement caused by a load is attached to the main body, such that the detection means detects the amount of displacement of the elastic mechanism.

However, in order for the elastic mechanism provided for detecting the amount of displacement to be constituted of an elastic member which is a separate member from the main body, space for mounting the elastic member is required, thus giving rise to the problem of an increase in size of the entire apparatus.

If, without using an elastic member, the main body is machined to provide a thin-walled portion to form the elastic mechanism, the machining is extremely complicated, thus giving rise to the problem of an increase in manufacturing costs.

### SUMMARY OF THE INVENTION

It is a first object of the present invention to provide a linear motion guide unit which is equipped with a force information detecting unit and makes possible a reduction in size and low-cost-manufacturing.

It is a second object of the present invention to provide a method for easily detecting strain occurring in a linear guide unit.

A first aspect of the present invention provides a linear motion guide unit which is provided with a casing having a mounting portion and a pair of wings combined with the mounting portion and facing each other across a track rail, the pair of wings being provided with rolling-contact faces facing the track rail and return holes interconnecting with the rolling-contact faces, and simultaneously incorporating rolling elements rolling on the rolling-contact faces and in the return holes, so that the rolling elements move the casing along the track rail while rolling between the rolling-contact faces and the track rail facing the rolling-contact faces. In the linear motion guide unit when a load acts on the casing and a force acts on the pair of wings in a direction of moving the pair of wings farther away from each other, bulge portions are created on the outer side faces of the pair of wings by the action of the force, and tensile-strain detection sensors are provided in the bulge portions, and compressive-strain detection sensors are provided in depression portions which are created next to the bulge portion in the direction of the mounting portion when the bulge portions are created.

A second aspect of the present invention provides a linear motion guide unit which is equipped with a casing having a mounting portion and a pair of wings combined with the mounting portion and facing each other across a track rail, the pair of wings being provided with rolling-contact faces facing the track rail and return holes interconnecting with the rolling-contact faces, and simultaneously incorporating rolling elements rolling on the rolling-contact faces and in the return holes, so that the rolling elements move the casing along the track rail while rolling between the rolling-contact faces and the track rail facing the rolling-contact faces. The linear motion guide unit comprises tensile-strain detection sensors each mounted on a portion of the pair of wings corresponding to a bulge portion which, when a load acts on the casing and a force acts on the pair of wings in a direction of moving the pair of wings farther away from each other; is created on the outer side face of each of the pair of wings by the action of the force, for a detection of a tensile strain; and compressive-strain detection sensors each mounted on a portion of the pair of wings corresponding to a depression portion which is created next to the bulge portion in the direction of the mounting portion when the bulge portion is created, for a detection of a compressive strain.

When a load acts on the casing, a bulge portion and a depression portion are created on the outer side faces of the wings of the casing, and strains having mutually contradictory properties, i.e. a tensile strain and a compressive strain, occur in the bulge portion and the depression portion. According to the present invention, attention is focused on the fact of the occurrence of strains having mutually contradictory properties, i.e. a tensile strain and a compressive strain as described above. A feature of the present invention is that strains are respectively detected in the bulging portion and the depression portion.

Measurement of the relative displacement difference between the tensile strain and the compressive strain enables precise detection of force information about the direction of the load acting on the casing, the magnitude of the load and the like, without extra provision of an elastic mechanism.

According to the first aspect of the present invention, the elimination of the need to provide an elastic mechanism on the main body makes possible a reduction in size of the entire apparatus and low-cost manufacturing.

According to the second aspect of the present invention, since the strain on the casing can be detected even without an elastic mechanism provided on the main body, strains can be readily detected even in an already-exiting apparatus and the information thus detected can be used to estimate the precise life and the like.

### BRIEF DESCRIPTION OF THE DRAWINGS

FIG. 1 is a perspective view illustrating a linear motion guide unit of an embodiment according to the present invention.

FIG. 2 is a sectional view taken along the axis direction of the linear motion guide unit of the embodiment.

FIG. 3A is a diagram illustrating a reaction force when a compressive load acts on the casing.

FIG. 3B is a diagram illustrating a reaction force when a tensile load acts on the casing.

FIG. 3C is a diagram illustrating a reaction force when rolling-direction moment acts on the casing.

FIG. 4 is a diagram showing the strain distribution when a force acts in the direction of moving a pair of wings farther away from each other.

FIG. 5 is a graph showing the values of the strain occurring on an outer side face of the casing.

FIG. 6 is a table showing the strain values and strain rates when a load of 10 kN acts.

FIG. 7 is a diagram illustrating the casing receiving the rolling-direction moment.

FIG. 8 is a graph showing the values of the strain occurring on the two outer side faces when the rolling-direction moment acts.

FIG. 9 is a table showing the strain rates on the two outer side faces when a rolling-direction moment of 300 Nm acts.

### DETAILED DESCRIPTION OF THE PREFERRED EMBODIMENT

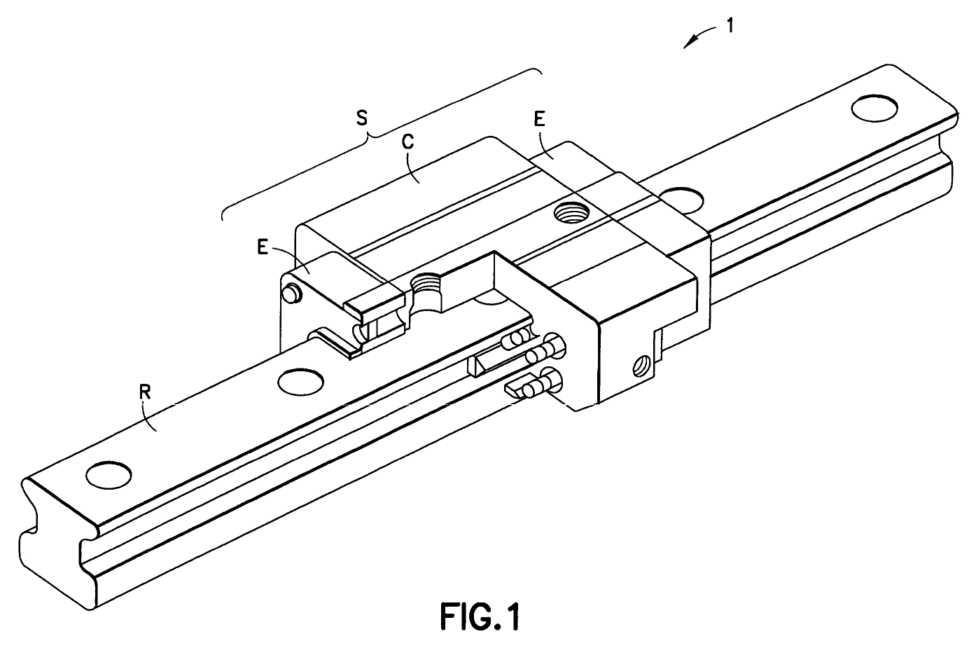

A linear motion guide unit of an embodiment according to the present invention will be described now with reference to FIG. 1 to FIG. 6.

The linear motion guide unit 1 shown in FIG. 1 slides along a track rail R, and a slider S is composed of a casing C and end caps E provided at the two ends of the casing C in the sliding direction.

The casing C of the slider S constituting the linear motion guide unit 1 is made up of a mounting portion 2 and a pair of wings 3. The mounting portion 2 lies over the track rail R and parallel to the top face of the track rail R, and the wings 3 extend downward from the two width-direction ends of the mounting portion 2 and are opposite each other across the track rail R.

Rolling-contact faces 4a to 4d are formed on the faces of the wings 3 facing the track rail t, and return holes 5a to 5d are drilled in positional correspondence with the rolling-contact faces 4a to 4d. The return holes 5a to 5d interconnect with the respective rolling-contact faces 4a to 4d through U-turn passages (not shown) which are formed in the end caps E in FIG. 1. Thus, a combination of the rolling-contact faces 4a to 4d, the return holes 5a to 5d and the U-turn passages formed in the end caps E forms circulating passages through which rollers 6 which are rolling elements circulate.

Accordingly, when the linear motion guide unit 1 is moved relative to the track rail R in the axis direction, the rollers 6 roll in the circulating passages to smooth the relative movement of the linear motion guide unit 1 and the track rail R.

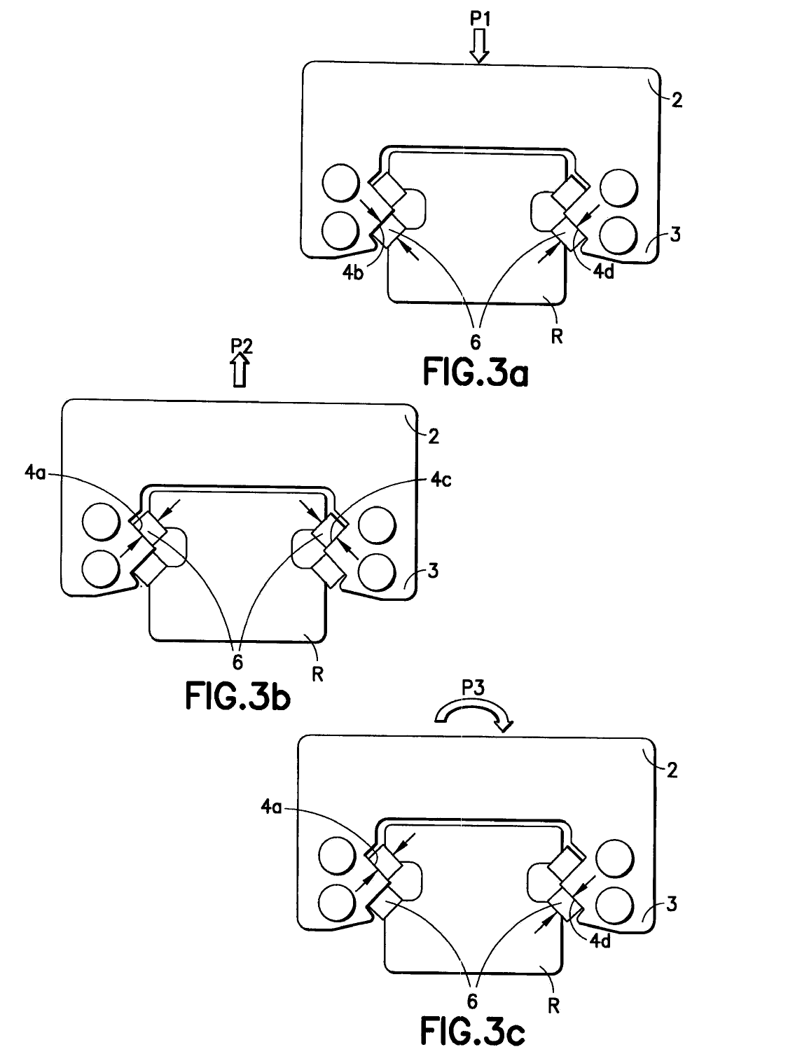

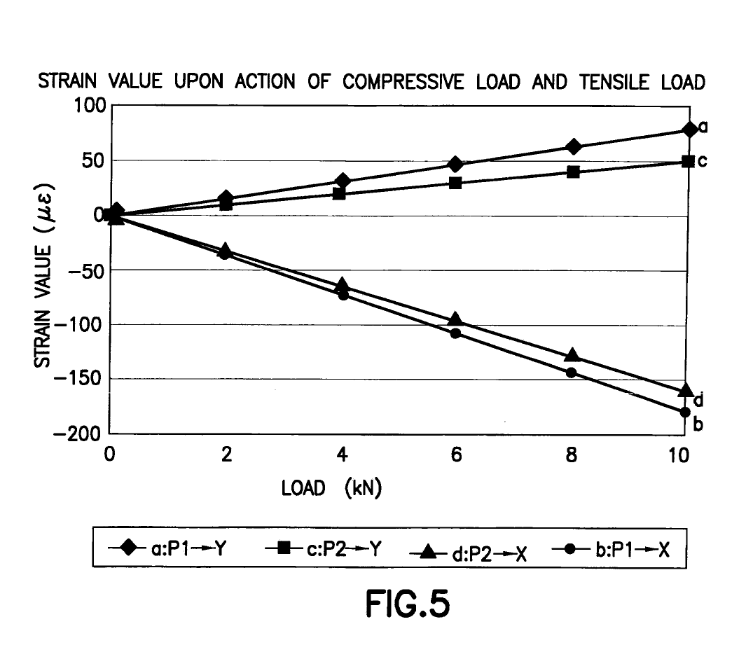

While the linear motion guide unit 1 runs on the track rail 1, in actuality loads act on the casing C from various directions as illustrated in FIGS. 3A to 3C.

For example, as shown in FIG. 3A, when a compressive load P1 acts on the casing in a downward direction, the rolling-contact faces 4b, 4d are pressed against the track rail R through the rollers 6. As a result, the casing C receives a reaction force from the track rail R through the rollers 6. The reaction force acts as a force to move the wings 3 farther away from each other.

On the other hand, as shown in FIG. 3B, when a tensile load P2 acts on the casing in an upward direction, the rolling-contact faces 4a, 4c are pressed against the track rail R through the rollers 6. As a result, the casing C receives a reaction force from the track rail R through the rollers 6. The reaction force acts as a force to move the wings 3 farther away from each other, as in the case in FIG. 3A.

As shown in FIG. 3C, when the rolling-direction moment P3 indicated with the arrow acts on the casing C, the rolling-contact faces 4a, 4d are pressed against the track rail R through the rollers 6. As a result, the casing C receives a reaction force from the track rail R through the rollers 6. The reaction force acts as a force to move the wings 3 farther away from each other, as in the case in FIG. 3A.

In each case, the casing C receives a force to move the wings 3 farther away from each other.

FIG. 4 shows the distribution of strain occurring on the casing C when the force to move the wings 3 farther away from each other acts on the casing C, obtained by FEM analysis. The following is a description relating to one of the wings 3.

When any load P of the loads P1 to P3 acts on the mounting portion 2 from above and the wings 3 receive a force to move them farther away from each other, a bulge portion Y and a depression portion X are created on the outer side face of the casing C. The reason why the bulge portion Y and the depression portion X are formed on the outer side face of the casing C in this manner is because the so-called tensile strain and compressive strain occur on the outer side face of the casing C. The tensile strain means the strain induced by tensile stress, and is expressed by a ratio in which a substance having a length L stretches under the action of tensile stress, that is, the strain value ε=+ΔL/L. The compressive strain means the strain induced by compressive stress, and is expressed by a ratio in which a substance having a length L stretches under the action of compressive stress, that is, the strain value ε=−ΔL/L.

As a result of actual measurement, the tensile strain and the compressive strain appear as follows.

Specifically, when the wings 3 receive the action of a force of moving them farther away from each other as described above, a large compressive strain occurs in the region central around the position X1 just as if the wings 3 bend outward about the position X1, and then the compressive strain gradually becomes smaller in the order X2→X→X4 with each step further away from X1. In addition, tensile strain, not compressive strain, occurs in the regions Y1, Y2 farther down from the X1.

In this manner, compressive strains differing in size occur on the outer side face of the casing C, and additionally a tensile strain having a property contrary to that of the compressive strain occurs in a part of the compressive strain. The bulge portion Y is created in the portion of the position Y1 in which the tensile strain occurs most strongly, and the depression portion X is formed in the portion of the position X1 in which the compressive strain occurs most strongly.

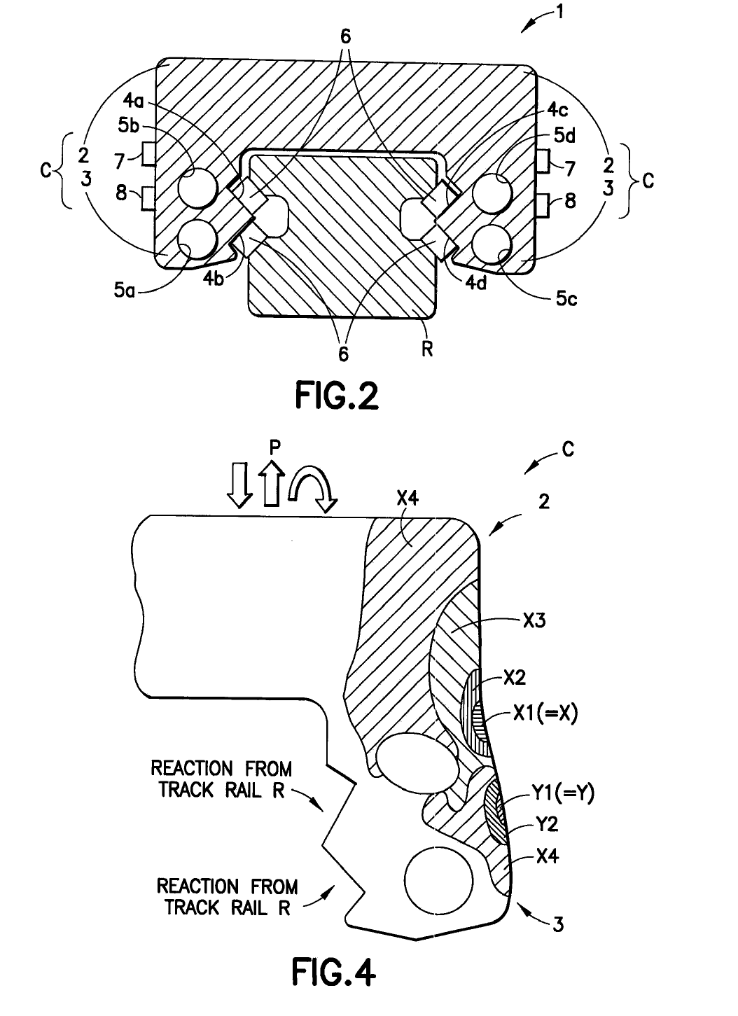

As shown in FIG. 2, the linear motion guide unit 1 is provided with a compressive strain detection sensor 7 in the depression portion X and a tensile-strain detection sensor 8 in the bulge portion Y. In this manner, the sensors 7 and 8 are respectively mounted in correspondence with the depression portion X originating in the position X1 in which the greatest compressive strain occurs, and with the bulge portion Y originating in the position Y1 in which the greatest tensile strain occurs, in order to detect the two directly-opposed strain values. A strain gauge is used as the sensor for detecting the strain in the embodiment.

FIG. 5 shows the strain values of the compressive strain occurring in the depression portion X and of the tensile strain occurring in the bulge portion Y which are detected by the sensors 7, 8 provided as described above when the compressive load P1 and the tensile load P2 act on the linear motion guide unit 1. FIG. 5 is determined by using FEM analysis to observe the changes in the above strain values when loads of from zero N to 10 kN act to the track rail R having a rail width of about 30 mm under theoretical conditions without preload.

In FIG. 5, when the compressive load P1 acts on the linear motion guide unit 1, the change in the strain value of the tensile strain occurring in the bulge portion Y is indicated by a, and the change in the strain value of the compressive strain occurring in the depression portion X is indicated by b. In addition, when the tensile load P2 acts on the linear motion guide unit 1, the change in the strain value of the tensile strain occurring in the bulge portion Y is indicated by c, and the change in the strain value of the compressive strain occurring in the depression portion X is indicated by d.

When either the compressive load P1 or the tensile load P2 acts on the linear motion guide unit 1, the greatest compressive strain occurs in the depression portion X and the greatest tensile strain occurs in the bulge portion Y as described above. As seen from FIG. 5, if the loads P1 and P2 are identical in magnitude, the compressive strain and the tensile strain produced under the action of the compressive load P1 are both greater than those produced under the action of the tensile load P2.

A probable reason why such different strain values are obtained regardless of the application of the equal-magnitude compressive load P1 and tensile load P2 is because the reaction forte from the track rail R acts on a different rolling-contact face depending on the load direction as described earlier.

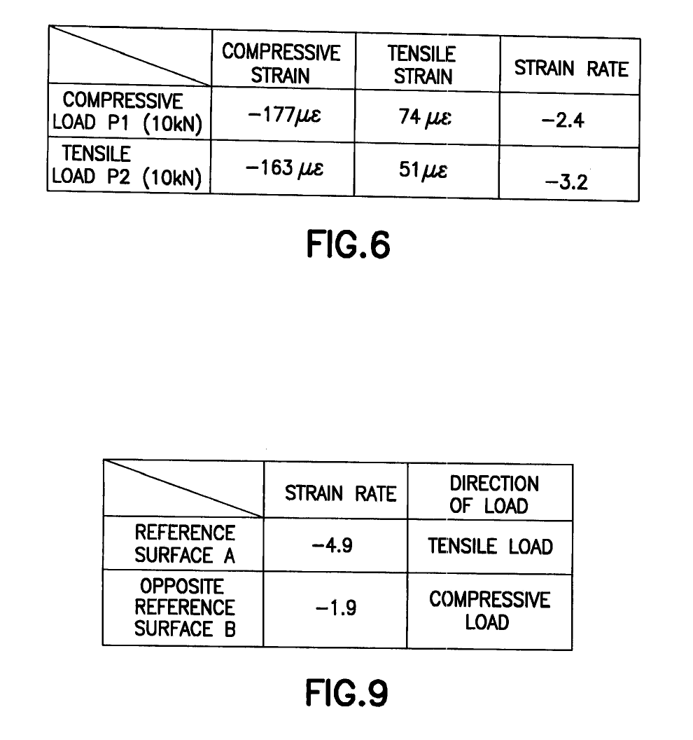

As shown in FIG. 6, the compressive strain when a compressive load P1 of 10 kN is applied to the linear motion guide unit 1 is −177με, and the tensile strain at this point is 74με. The compressive strain when a tensile load P2 of 10 kN is applied to the linear motion guide unit 1 is −163με, and the tensile strain at this point is 51με.

In addition, an operational expression of compressive strain/tensile strain is used to obtain a strain rate from the strain values thus detected. As a result, the strain rate when the compressive load P1 acts is −2.4, and the strain rate when the tensile load P2 acts is −3.2.

In this manner, even under the action of equal-magnitude loads, different strain rates are obtained depending on the load directions. Further, as shown in FIG. 5, since the strain values detected by the sensors 7, 8 are proportional to the magnitudes of the loads P1, P2, the strain rates calculated as described above result in approximately the same numerical values regardless of the magnitude of the load acting. In other words, even in the case of the action of equal-magnitude loads, if the absolute value of the calculated strain rate is large, it is possible to determine that the tensile load P2 is acting. The numeric values shown in FIGS. 5 and 6 are based on FEM analysis, but it has been found that the strain value and the load are in approximately proportional relationship when the strain value is actually measured.

Accordingly, if the compressive strain and the tensile strain occurring on the outer side face of the casing C are detected and the strain rate is calculated on the basis of the strain values thus detected, it is possible to readily determine what compressive load P1 acts and what tensile load P2 acts on the linear motion guide unit 1.

If different strain rates are obtained between the two wings 3, it is possible to determine which direction the rolling-direction moment P3 is acting in.

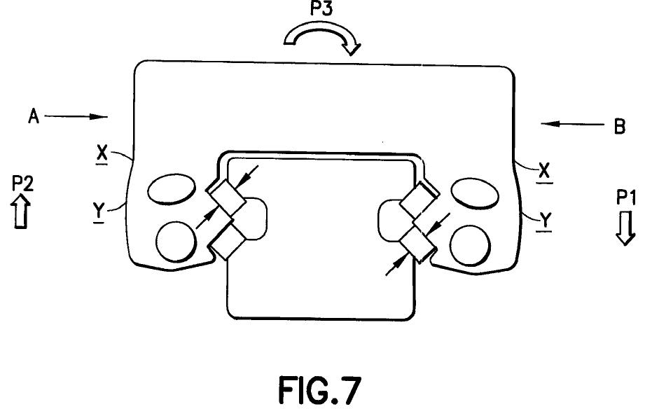

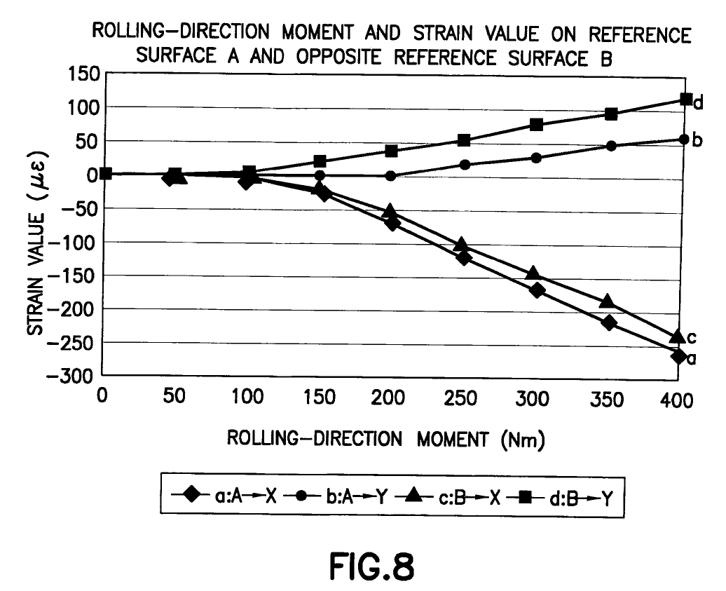

Specifically, the outer side face of one of the pair of wings 3 is defined as a reference surface A and the outer side face of the other wing 3 is defined as the opposite reference surface B. As shown in FIG. 7, under the action of the rolling-direction moment P3 indicated by the arrow, the tensile load P2 acts on the reference surface A and the compressive load P2 acts on the opposite reference surface B. FIG. 8 shows the relationship between the moment P3 as described above, and the tensile load P2 acting on the reference surface A and the compressive load P1 acting on the opposite reference surface B.

FIG. 8 is determined by actual measurement of the strain values when the moment P3 acts on the linear motion guide unit under preload. When the magnitude of the moment P3 ranges from zero to 100 Nm, no difference between the strain values is produced because of the preload, but certain law as described below comes into play around the time when the moment P3 exceeds 100 Nm.

In FIG. 8, when the rolling-direction moment P3 acts on the linear motion guide unit 1, the change in the strain value of the compressive strain occurring in the depression portion X on the reference surface A is indicated by a, and the change in the strain value of the tensile strain occurring in the bulge portion Y is indicated by b. In addition, the change in the strain value of the compressive strain occurring in the depression portion X on the opposite reference surface B is indicated by c, and the change in the strain value of the tensile strain occurring in the bulge portion Y is indicated by d.

As is seen from FIG. 8, the compressive strain value of the depression portion X on the reference surface A is greater in absolute value than the compressive strain value of the depression portion X on the opposite reference surface B, whereas the tensile strain value of the bulge portion Y on the reference surface A is smaller than the tensile strain value of the bulge portion Y on the opposite reference surface B. In addition, the change in each value rises approximately proportionally to the moment P3.

As shown in FIG. 9, the strain rate when a moment P3 of 300 Nm is applied to the linear motion guide unit 1 is calculated by the aforementioned operational expression. The strain rate in the reference surface A results in −4.9 and the strain rate in the opposite reference surface B results in −1.9.

If the strain rates in the two outer side faces of the respective wings 3 are calculated, when the rolling-direction moment acts, different strain rates are obtained between the two reference surfaces A, B. In addition, as shown in FIG. 8, the strain values detected by the sensors 7, 8 are approximately proportional to the magnitude of the moment P3 at all points after the range under the influence of preload has been exceeded. Accordingly, the strain rates calculated as described above take an approximately the same value regardless of the magnitude of the acting moment. It goes without saying that, when the rolling direction of the moment P3 is reversed, the strain values calculated for the reference surface A and the opposite reference surface B are also reversed without any change.

That is, when different strain rates between the reference surface A and the opposite reference surface B are calculated, it is possible to readily determine which direction the rolling-direction moment is acting in.

Further, the strain values thus detected can be used to check the setting precision at the time of setting the linear motion guide unit and to check the life of the linear motion guide unit, for example.

For example for an examination of the track rail R to confirm its installation position parallel to the installation face, a linear motion guide unit 1 should be slid while receiving the action of a predetermined load. If the track rail R is laid with an inclination, the strain values detected differ between the two wings 3. As a result, the direction in which the track rail R is inclined can be easily detected.

Further, what is required for an examination of the parallel installation of a pair of track rails R is to mount linear motion guide units 1 astride the respective track rails: R, then to couple the two linear motion guide units 1 to each other and then to slide the linear motion guide units 1 while equally applying a predetermined load thereto. If the pair of track rails R are laid parallel to each other, a constant strain value is detected during the examination, but if they are laid out of parallel to each other, the strain value fluctuates. As a result it is possible to easily detect whether or not the pair of track rails R are laid parallel to each other.

Further, if the strain value and the strain rate are calculated in advance for each operation process under normal conditions and then are stored in a computer, an abnormal condition in each area caused by thermal expansion can be easily detected from the change in the detected value.

Since the load acting can be measured from the strain value, it is possible to derive the theoretical life of a product from the load.

According to the embodiment, in the bulge portion Y and the depression portion X which are created when a load acts on the casing C, strains having mutually contradictory properties, i.e. a tensile strain and a compressive strain, are detected. In consequence, the need for specially providing an elastic mechanism is eliminated, and accurate detection of the load acting on the casing C is possible while a reduction in size of the entire apparatus and low-cast manufacturing are achieved.

By simply mounting the sensors 7, 8 on an already-existing apparatus, the detection of the tensile strain and the compressive strain as described above facilitates the detection of strains at low cost. Further, if the strain values detected by the sensors 7, 8 are transmitted to peripheral equipment by wireless, the need for using a code and the like is eliminated, resulting in further simplification in structure.

In this manner, according to the embodiment, in addition to the structure's capability of being reduced in size and manufactured at low cost, the detection of the compressive strain and the tensile strain occurring on the outer side faces of the casing C enables an easy check for precision of setting, the life of the apparatus, abnormal conditions under operation, and the like, thus enabling the prevention of the failure of the apparatus and quick dealing with the cause of the failure.

In the embodiment rollers are used as the rolling elements, but the rolling elements may be balls.

The tensile-strain detection sensor 8 is provided underneath the compressive-strain detection sensor 7 in the vertical direction, but the sensors 7, 8 are not necessarily arranged in the vertical direction. However, it goes without saying that, if the sensors 7, 8 are arranged in the vertical direction, the strain value can be detected with increased accuracy, and also if a plurality of sets of sensors 7, 8 are arranged in the axis direction, the strain value can be detected with further increased accuracy.

In the case of detecting only a load acting in the vertical direction, the sensors 7, 8 may be provided only on one of the wings 3.

What is claimed is:

1. A linear motion guide unit which is provided with a casing having a mounting portion and a pair of wings combined with the mounting portion and facing each other across a track rail, the pair of wings being provided with rolling-contact faces facing the track rail and return holes interconnecting with the rolling-contact faces, and simultaneously incorporating rolling elements rolling on the roiling-contact faces and in the return holes, so that the rolling elements move the casing along the track rail while rolling between the rolling-contact faces and the track rail facing the rolling-contact faces, wherein:
when a load acts on the casing and a force acts on the pair of wings in a direction of moving the pair of wings farther away from each other, bulge portions are created on the outer side faces of the pair of wings by the action of the force, and tensile-strain detection sensors are provided in the bulge portions, and compressive-strain detection sensors are provided in depression portions which are created next to the bulge portion in the direction of the mounting portion when the bulge portions are created.

2. A linear motion guide unit which is provided with a casing having a mounting portion and a pair of wings combined with the mounting portion and facing each other across a track rail, the pair of wings being provided with rolling-contact faces facing the track rail and return holes interconnecting with the rolling-contact faces, and simultaneously incorporating rolling elements rolling on the rolling-contact faces and in the return holes, so that the rolling elements move the casing along the track rail while rolling between the rolling-contact faces and the track rail facing the rolling-contact faces, the linear motion guide unit comprising:
tensile-strain detection sensors each mounted on a position corresponding to a bulge portion which, when a load acts on the casing and a force acts on the pair of wings in a direction of moving the par of wings farther away from each other, is created on the outer side face of each of the pair of wings by the action of the force, for a detection of a tensile strain; and
compressive-strain detection sensors each mounted on a position corresponding to a depression portion which is created next to the bulge portion in the direction of the mounting portion when the bulge portion is created, for a detection of a compressive strain.
